(19) United States
(12) Patent Application Publication
(10) Pub. No.: US 2024/0239673 A1
(43) Pub. Date: Jul. 18, 2024

(54) METHOD FOR PRODUCING AMMONIACAL NITROGEN

(71) Applicants: CENTRE NATIONAL DE LA RECHERCHE SCIENTIFIQUE, PARIS (FR); UNIVERSITÉ TOULOUSE III - PAUL SABATIER, TOULOUSE Cedex 9 (FR)

(72) Inventors: Nicolas MEZAILLES, TOULOUSE (FR); Soukaina BENNAAMANE, TOULOUSE (FR)

(73) Assignees: CENTRE NATIONAL DE LA RECHERCHE SCIENTIFIQUE, PARIS (FR); UNIVERSITÉ TOULOUSE III - PAUL SABATIER, TOULOUSE Cedex 9 (FR)

(21) Appl. No.: 18/562,040

(22) PCT Filed: May 19, 2022
(86) PCT No.: PCT/EP2022/063538

§ 371 Date: Nov. 17, 2023

(30) Foreign Application Priority Data
May 20, 2021 (FR) 2105295

(51) Int. Cl. C01C 1/02

(52) U.S. Cl. CPC C01C 1/02

(57) ABSTRACT

A method for producing ammonia nitrogen, using dinitrogen reduction in the presence of a compound (I), which includes at least one element from group 13 of the periodic table of elements, The method includes a step of bringing into contact with dinitrogen a composition that includes the compound (I), a reducing agent, and an organ solvent and a hydrolysis step in an acid medium. Also the use of this compound (I) for dinitrogen reduction.

### FIELD

This invention relates to a process for producing ammoniacal nitrogen implementing dinitrogen reduction in the presence of a compound (I) comprising at least one element of group 13 of the periodic table, and a reducing agent; and the use of said compound (I) for dinitrogen reduction.

### BACKGROUND

Nitrogen (N) plays an essential role in the composition of living matter. It is especially one of the major constituents of amino acids, proteins including enzymes, and nucleic acids making up DNA and RNA. It is also an essential nutrient for crop growth. However, although nitrogen is very abundant on the earth's surface (there is more nitrogen than carbon, hydrogen and phosphorus combined in the totality of biosphere, hydrosphere and atmosphere), it is essentially present in the form of an extremely stable gas, dinitrogen (N₂). Humans can only marginally benefit from this abundance. Only micro-organisms such as the Rhizobia involved in symbiotic nitrogen fixation by legumes are capable of using this form of nitrogen and transforming it into ammoniacal nitrogen and then organic nitrogen, which can in turn be used by other living beings and transformed into other forms of reactive nitrogen.

To meet an increased demand for reactive nitrogen for food production since the industrial revolution at the end of the 19th century, two main processes have drastically altered this reactive nitrogen landscape. Firstly, the increasingly massive use of fossil fuels (coal, petrol, natural gas, etc.) for energy production, transport, industry and domestic activities has greatly increased amounts of oxidised nitrogen present in the environment. The second most important process is the Haber-Bosch process, which enables ammonia to be synthesised on an industrial scale from dinitrogen and dihydrogen (H₂) in the presence of a solid, especially iron-based, catalyst. Since the end of the 20th century, this process has produced about 200 million tonnes/year of ammonia NH₃ on a global scale, more than symbiotic fixation, and it is still in use today. However, this Haber-Bosch process has the following disadvantages: it implements high pressures and temperatures, for example pressures of between 100 and 300 bar and temperatures of between 300 and 550° C., making this process extremely energy-intensive, requiring centralised and secure production, and involving high operating and transport costs. Moreover, such a process generates very large amounts of carbon dioxide (about 1.5% of overall CO₂ production), leading to environmental problems, and its yield remains low (20%).

Research has been conducted into ammonia production processes that implement milder conditions, such as electrochemical reduction, which involves applying an electrical potential to an electrocatalyst based on noble metals such as gold or ruthenium. However, yields remain low and raw materials are rare and extremely expensive. Other processes have been developed using organometallic complexes or compounds of transition metals. In particular, U.S. Pat. No. 6,037,459 describes a process comprising a step of bringing a compound responding to the formula M(NR₁R₂)₃ in which M is a transition metal (e.g. molybdenum), R₁ and R₂ are selected from tertiary alkyl groups, phenyl groups and substituted phenyl groups, into contact with nitrogen to form a metal complex with nitride ligands; and a step of reducing said complex in the presence of a hydrogen source to form ammonia. This process is carried out under ambient temperature and pressure conditions. However, U.S. Pat. No. 6,037,459 describes low yields and the formation of ammonia is not demonstrated.

### SUMMARY

The aim of the present invention is therefore to overcome the drawbacks of prior art and especially to provide a process for producing ammoniacal nitrogen that is simple, economical, can be industrialised, uses abundant raw materials, that can be possibly recycled, and enables carbon emissions to be reduced.

A first object of the invention is a process for producing ammoniacal nitrogen, characterised in that it comprises at least the following steps:
i) a step of bringing a composition comprising a compound responding to a following formula (I): R¹R²MY (I), a reducing agent, and an organic solvent, into contact with dinitrogen (N₂),
said formula (I) being such that:
   M is an element of group 13 of the periodic table, preferably selected from boron, aluminium, and a mixture thereof,
   R¹ and R², identical or different, are selected from an alkyl group, an aryl group, an aryl-alkyl group, an —OR group and an —SR group, R being an alkyl group, an aryl group or an aryl-alkyl group, and
   Y is a group selected from a halogen —X, an —OR³ group, an —SR³ group, a triflate group, a mesylate group, and a triflimidate group, R³ being an alkyl group, an aryl group, or an aryl-alkyl group, and
ii) a hydrolysis step in acidic medium.

### DETAILED DESCRIPTION

The process of the invention is simple, easy to implement and economical, and enables ammoniacal nitrogen to be obtained under relatively mild reaction conditions. In particular, the use of a compound of formula (I) as defined above enables the triple bond of dinitrogen to be activated in reducing medium and intermediate species to be formed which then lead to ammoniacal nitrogen by hydrolysis. Finally, the process can be industrialised, uses abundant raw materials, which may possibly be recycled, and enables environmental impact to be reduced.

### Step i)

The compound of formula (I) R¹R²MY

According to the invention, boron is particularly preferred as the element M.

The compound of formula (I) R¹R²MY is not a radical compound.

In the compound of formula (I), R¹ forms a single covalent bond with element M and R² forms a single covalent bond with element M.

The R¹ and R² groups

R¹ and R², the same or different, are selected from an alkyl group, an aryl group, an aryl-alkyl group, an —OR group, and an —SR group, R being an alkyl group, an aryl group, or an aryl-alkyl group.

An alkyl group as an R¹ and/or R² group may be linear or branched, cyclic or non-cyclic. The alkyl group may comprise from 1 to 14 carbon atoms, and preferably from 2 to 10 carbon atoms. An alkyl group is preferably selected from ethyl, propyl, isopropyl, cyclohexyl, bicyclo[2.2.1]-2-heptyl and isopinocamphenyl groups. Among such groups, any one of the cyclohexyl, bicyclo[2.2.1]-2-heptyl or isopinocamphenyl groups is particularly preferred.

The alkyl group as R¹ and/or R² group may comprise one or more heteroatoms, such as an oxygen atom, or a sulphur atom, it being understood that a carbon atom of the alkyl group is directly bound to element M of the formula (I) and that none of the heteroatom(s) present in the alkyl group is directly covalently bound to another heteroatom.

An aryl group as an R¹ and/or R² group may be substituted or unsubstituted. The aryl group may comprise from 6 to 30 carbon atoms, and preferably from 6 to 18 carbon atoms. An aryl group is preferably selected from a phenyl group, a —C₆F₅ group, a 2,4,6-(Me)₃-C₆H₂ group, and a 2,4,6-(iPr)₃-C₆H₂ group. Among such groups, any one of the 2,4,6-(Me)₃-C₆H₂ or 2,4,6-(iPr)₃-C₆H₂ groups is particularly preferred.

The aryl group as an R¹ and/or R² group may comprise one or more heteroatoms, especially when the aryl group is substituted (i.e. in the substituents of said aryl group), such as an oxygen atom or a nitrogen atom, it being understood that a carbon atom of the aryl group is directly bound to element M of the formula (I).

An aryl-alkyl group as an R¹ and/or R² group is a group comprising at least one alkyl group and at least one aryl group which are directly bound by a covalent carbon (of the aryl group)-carbon (of the alkyl group) bond, or via an oxygen atom or a nitrogen atom, the aryl and alkyl groups being as defined above for the R¹ and R² groups. The alkyl-aryl group may be directly bound to element M of the formula (I) via a carbon atom of the aryl group or via a carbon atom of the alkyl group.

An R alkyl group of the —OR or —SR group may be linear or branched, cyclic or non-cyclic. The R alkyl group may comprise from 1 to 10 carbon atoms, and preferably from 1 to 4 carbon atoms.

An R aryl group of the —OR or —SR group may be substituted or unsubstituted. The R aryl group may comprise from 6 to 30 carbon atoms, and preferably from 6 to 18 carbon atoms. An R aryl group is preferably selected from a phenyl group, a naphthyl group, an anthracenyl group or a pyrenyl group.

An R aryl-alkyl group of the —OR or —SR group is a group comprising at least one alkyl group and at least one aryl group which are directly bound by a covalent carbon (of the aryl group)-carbon (of the alkyl group) bond or via an oxygen atom or a sulphur atom, the aryl and alkyl groups being as defined above for the R group.

The R¹ and R² groups may be covalently bound, especially via a carbon-carbon bond, to form a divalent group together, said R¹ and R² groups being as defined above. In this embodiment, the divalent group does not form a planar ring with element M.

By way of example, the divalent group may be an alkyl group (i.e. R¹ and R² are alkyl groups), and preferably a 9-bicyclo[3.3.1]nonane group.

According to one embodiment of the invention, R¹ and R², identical or different, are selected from an alkyl group, an aryl group and an aryl-alkyl group.

According to a preferred embodiment of the invention, at least one of the groups R¹ and R² is an alkyl group, and particularly preferably both groups R¹ and R² are alkyl groups.

According to a particularly preferred embodiment of the invention, R¹ and R² are identical.

The R¹ and R² groups of compound (I) are non-stabilising groups. In other words, their function is not to stabilise the R¹R²M° radical generated during the process, and consequently to make it more reactive towards nitrogen N₂.

### The Y Group

Y is a group selected from a halogen —X, a —OR₃ group, a —SR₃ group, a triflate (—OSO₂CF₃) group, a mesylate (—OSO₂CH₃) group, and a triflimidate (NTf₂ or N(SO₂CF₃)₂) group, R³ being an alkyl, aryl, or aryl-alkyl group.

X is preferably a chlorine atom or a bromine atom, and particularly preferably a chlorine atom.

An R³ alkyl group may be linear or branched, cyclic or non-cyclic. The R³ alkyl group may comprise from 1 to 10 carbon atoms, and preferably from 1 to 4 carbon atoms.

An R³ aryl group may be substituted or unsubstituted. The R³ aryl group may comprise from 6 to 30 carbon atoms, and preferably from 6 to 18 carbon atoms. An R³ aryl group is preferably selected from phenyl, 2,4,6-(Me)₃-C₆H₂, 2,4,6-(iPr)₃-C₆H₂ and naphthyl groups.

An aryl-alkyl R³ group is a group comprising at least one alkyl group and at least one aryl group which are directly bound by a covalent carbon (of the aryl group)-carbon (of the alkyl group) bond or via an oxygen atom or a sulphur atom, the aryl and alkyl groups being as defined above for the R³ group.

Y is preferably a halogen X.

Y group of compound (I) is a group with nucleofugal properties. In other words, its function is to facilitate formation of the R¹R²M° radical.

According to a particularly preferred embodiment of the invention, the compound of formula (I) is selected from dialkylchloroboranes, dialkylbromoboranes, dialkylchloroaluminium compounds and dialkylbromoaluminium compounds, such as diisopinocampheylborane, dicyclohexylborane or bis(bicyclo[2. 2.1]-2-heptyl)borane halides, or haloboranes based on 9-borabicyclo[3.3.1]nonane.

The compound of formula (I) has the advantages of being readily commercially available or of being readily synthetically accessible.

The compound of formula (I) has the characteristics of a Lewis acid, namely a chemical entity in which one of its constituent atoms has an electron vacancy.

The reducing agent can be selected from potassium, sodium, mercury- and sodium-based amalgams, lithium, and a mixture thereof; and preferably potassium.

The use of an amalgam makes it easier to weigh the amount of reducing agent to be used in step i).

The organic solvent may be a conventional organic solvent, an ionic liquid, or a mixture.

An ionic liquid is well known to the skilled person and can be considered as a molten salt at room temperature (e.g. 18-25° C.). The ionic liquid has an organic cationic part and acts as a solvent in the present invention, in the same way as a conventional organic solvent.

In the invention, by conventional organic solvent, it is meant an organic solvent which is free of salt or which is not in the form of a salt.

The organic solvent of step i) is preferably selected from aprotic organic solvents.

According to one embodiment of the invention, the organic solvent of step i) is selected from apolar aprotic organic solvents (as conventional organic solvents), ionic liquids, and a mixture thereof.

According to a first alternative to this embodiment, the organic solvent of step i) is selected from apolar aprotic organic solvents.

According to a second alternative to this embodiment, the organic solvent in step i) is selected from ionic liquids.

The apolar aprotic organic solvent of step i) is preferably selected from THF (tetrahydrofuran) and methyl-THF.

The ionic liquid of step i) is preferably selected from ammonium salts, imidazolium salts, phosphonium salts, pyrrolidinium salts and piperidinium salts, and particularly preferably from alkylammonium salts, alkylimidazolium salts, alkylphosphonium salts, alkylpyrrolidinium salts and alkylpiperidinium salts.

The ionic liquid of step i) preferably comprises an anionic part of the bis(trifluoromethanesulphonyl)imidate type.

By way of example of ionic liquids, mention may be made of triethylbutylammonium bis(trifluoromethanesulphonyl)imidate, 1-butyl-3-methylimidazolium bis(trifluoromethanesulphonyl)imidate, 1-ethyl-3-methylimidazolium bis(trifluoromethanesulphonyl)imidate, trimethylbutylammonium bis(trifluoromethanesulphonyl)imidate, 1-buty-1-methylpyrrolidinium bis(trifluoromethanesulphonyl)imidate, N-propyl-N-methylpyrrolidinium bis(trifluoromethanesulphonyl)imidate, or 1-butyl-3-methylimidazolium bis(trifluoromethanesulphonyl)imidate.

The ionic liquid is preferably immiscible in water. This facilitates subsequent purification operations.

During step i), the composition comprising the compound of formula (I), the reducing agent and the organic solvent is brought into contact with dinitrogen (N₂).

Step i) is carried out in dry or anhydrous medium. In other words, step i) is preferably carried out in a glove box or in a suitable device to avoid contact with air and/or moisture.

Indeed, contact with moisture and/or air leads to the formation of by-products such as H₂ and/or R¹R²MOMR¹R².

Step i) may last from about 1 h to 20 h, and preferably from about 2 h to 12 h.

Step i) is preferably carried out at a temperature ranging from about −80° C. to 60° C., and particularly preferably from about 0° C. to 30° C.

Step i) is preferably implemented under stirring, for example using a mechanical or magnetic stirrer. Stirring makes it possible to promote contact between the composition and the dinitrogen, and thus to promote the reaction.

In order to allow reaction between the dinitrogen and compound (I), the reaction is preferably carried out under a dinitrogen atmosphere, especially dry dinitrogen.

Step i) can be carried out at a pressure ranging from about 0.1 bar to 200 bar, and preferably from 1 bar to 100 bar. A pressure of at least 20 bar, and preferably at least 40 bar, is advantageous for improving the yield of ammoniacal nitrogen. A pressure of 1 bar is advantageous from an industrial point of view.

The reducing agent used in step i) may represent from 0.1% to 20% by weight, and preferably from 0.1% to 10% by weight, relative to the total weight of the composition.

The compound of formula (I) used in step i) may represent from 0.1% to 10% by weight, and preferably from 2% to 6% by weight, relative to the total weight of the composition.

During step i), the compound (I) reacts with dinitrogen to form one or more species based on nitrogen and element M, in particular of the following formula (II): N(MR¹R²)₃₋ₓHₓ, x being an integer ranging from 0 to 3.

The formation of one or more species based on nitrogen and element M as defined above is explained especially by conducting a radical chain reaction implementing one or more radicals at least based on element M which are sufficiently unstable to react with nitrogen of the dinitrogen.

Surprisingly, compound (I), by virtue of its formula (I) and thus the definition of Y, M, R¹ and R², has the ability to activate the triple bond of the dinitrogen in reducing medium and to minimise or even avoid dimerisation of the radical.

### Step ii)

During step ii), the species based on nitrogen and element M are hydrolysed in acidic medium to form ammoniacal nitrogen.

In the invention, ammoniacal nitrogen includes the two most reduced forms of nitrogen: ammonium (NH₄⁺) and ammonia (NH₃). Ammoniacal nitrogen is therefore selected from ammonium (NH₄⁺), ammonia (NH₃) and a mixture thereof. Generally speaking, according to the conditions of step ii), and especially the amount of acid, ammonium (excess acid) or ammonia (stoichiometric amounts with respect to N(MR¹R²)₃₋ₓHₓ) will be obtained.

Step ii) of hydrolysis in acidic medium can be implemented by bringing a reaction crude obtained in preceding step i) into contact with an acidic solution or with a gaseous acid (in the form of a gas).

The acidic solution may comprise an aqueous solvent (e.g. water) and at least one acid such as hydrochloric acid, hydrobromic acid, sulphuric acid or nitric acid, or an aprotic organic solvent and at least one acid such as hydrochloric acid, hydrobromic acid, sulphuric acid or nitric acid.

The aprotic organic solvent may be selected from ethers such as diethyl ether or dioxane, and alkanes such as hexane or heptane.

The gaseous acid may be hydrochloric acid gas.

Step ii) advantageously leads to ammonium, especially when the acid is used in excess relative to the compound of formula (I).

The aqueous solvent is preferably water.

The acidic solution may have a pH ranging from about 0 to 6.

Step ii) may last from about 1 min to 30 min, and preferably from about 2 min to 10 min. Step ii) is a very rapid, almost instantaneous step.

Step ii) is preferably carried out at a temperature ranging from about −20° C. to 40° C., and particularly preferably from about 0° C. to 20° C.

Step ii) is preferably implemented with stirring.

Step ii) is preferably carried out at atmospheric pressure.

Step ii) enables to lead to ammonia NH₃ and/or ammonium NH₄⁺.

### Other Steps of the Process

The process may further comprise, after step i) and before step ii), a step i′) during which the organic solvent is removed.

This embodiment is particularly adapted when the organic solvent is a conventional organic solvent.

Step i′) may be carried out by evaporating the conventional organic solvent.

The process may comprise a purification step i″) after step i) or step i′) if present. This step i″) makes it possible to remove at least some of the by-products (e.g. salts) possibly formed during step i). In other words, step i″) makes it possible to separate the species based on nitrogen and element M formed in step i), from the salts.

Step i″) can be carried out by extracting a reaction mixture formed in step i) or step i′) if present, especially using an apolar organic solvent. The species or species based on nitrogen and element M formed in step i) are soluble in said apolar organic solvent and can be separated from the salts by filtration.

The apolar organic solvent may be selected from alkanes such as hexane, pentane or heptane.

The preferred apolar organic solvent is pentane.

When the organic solvent of step i) is a conventional organic solvent, purification step i″) may be carried out after step i) or step i′), in particular by extraction of a reaction mixture formed in step i) or step i′) as explained above.

When the organic solvent of step i) is an ionic liquid, purification step i″) may be carried out after step i), in particular by extracting a reaction mixture formed in step i) as explained above.

The process may further comprise, before step i), a step i0) of preparing the compound of formula (I).

The compound of formula (I) can be prepared according to a double hydroboration or hydroalumination protocol as described in the following papers: H. C. Brown, N. Ravindran, J. Am. Chem. Soc. 1976, 98, 1798-1806 and H. C. Brown, N. Ravindran, J. Am. Chem. Soc. 1976, 98, 1785-1798; or according to the reaction of two equivalents of alkene with one equivalent of a monohaloborane (e.g. responding to the formula YBH₂ in which Y is as defined in the invention) in THF or diethyl ether, at room temperature.

Generally speaking, one equivalent of the compound MH₂Y reacts with two equivalents of an alkene R′CH═CH₂ to form the compound (R′CH₂CH₂)₂MY.

The process of the invention preferably does not implement any gaseous species other than dinitrogen (N₂) as a starting reagent.

The process may further comprise a step iii) of recycling compound (I). In this embodiment, step ii) is preferably conducted by bringing the reaction crude obtained in preceding step i), i′) or i″) into contact under an inert atmosphere with an acidic solution comprising an aprotic organic solvent and at least one acid, or with a gaseous acid, said acidic solution and said gaseous acid being as defined above.

Step iii) can thereby be carried out after step ii) in the following way:
when the organic solvent is a conventional organic solvent: for example by removing the solvents from steps i), i″), and ii) if present, preferably by evaporation, and using an apolar organic solvent to precipitate NH₄⁺ and separate/recover the compound (I); or
when the organic solvent is an ionic liquid: for example by removing the solvents from steps i″) and ii) if present, and using a distillation system to recover NH₃ and separate/recover the compound (I).

The apolar organic solvent may be as previously defined.

The second object of the invention is the use of a compound of formula (I) as defined in the invention, for dinitrogen reduction.

### EXAMPLES

### Example 1: Process for Producing Ammoniacal Nitrogen from Dinitrogen Implementing Dicyclohexylchloroborane as a Compound of Formula (I)

120 mg of a solution of dicyclohexylchloroborane (1M in hexane) marketed under reference 411124 by Sigma-Aldrich have been added to 4 mL of anhydrous tetrahydrofuran, followed by 15 mg of potassium. The resulting composition has been placed under a pure, dry dinitrogen atmosphere and under stirring for 12 hours. At the end of the reaction, the mixture is brown in colour. An excess of HCI (2 M) in Et₂O has been added under an inert atmosphere, allowing quantitative conversion of Hx-N(BCy₂)₃₋ₓ into NH₄⁺ and Cy₂BCl. Solvents and volatile compounds have been removed by evaporation, leaving a solid residue. This solid is extracted with hexane, allowing separation of Cy2BCl from NH₄⁺.

NH₄⁺ is obtained as a white solid. The yield with respect to the Cy₂BCl initially introduced is 38%.

### Example 2: Process for Producing Ammoniacal Nitrogen from Dinitrogen Implementing (+)-B-Chlorodiisopinocampheylborane as a Compound of Formula (I)

48 mg of (+)-B-Chlorodiisopinocampheylborane (Ipc₂BCl) marketed under reference 317012 by Sigma-Aldrich have been added to 4 mL of anhydrous tetrahydrofuran, followed by 15 mg of potassium. The resulting composition has been placed under a pure, dry dinitrogen atmosphere and under stirring for 12 hours. At the end of the reaction, the mixture is brown in colour. An excess of HCI (2 M) in Et₂O has been added under an inert atmosphere, allowing quantitative conversion of Hₓ—N(BIpc₂)₃₋ₓ into NH₄⁺ and Cy₂BCl. Solvents and volatile compounds have been removed by evaporation, leaving a solid residue. This solid is extracted with hexane, allowing the separation of Ipc₂BCl from NH₄⁺.

NH₄⁺ is obtained as a white solid. The yield with respect to the Ipc₂BCl initially introduced is 15%.

### Example 3: Control Process (not Part of the Invention)

120 mg of a solution of dicyclohexylchloroborane (1M in hexane) marketed under reference 411124 by Sigma-Aldrich have been added to 4 mL of anhydrous tetrahydrofuran, followed by 15 mg of potassium. The resulting composition has been placed in a pure, dry argon atmosphere and under stirring for 12 hours. An excess of HCI (2 M) in Et₂O has been added under an inert atmosphere. No NH₄⁺ formation has been observed.

### Example 4: Control Process (not Part of the Invention)

A suspension of 15 mg of potassium in 4 mL of anhydrous tetrahydrofuran has been stirred under an atmosphere of pure, dry dinitrogen for 12 hours. An excess of HCI (2 mol/l) in Et₂O has been added under an inert atmosphere. No NH₄⁺ formation has been observed.

### Example 5: Process for Producing Ammoniacal Nitrogen from Dinitrogen Implementing Bis(Bicyclo[2.2.1]-2-Heptyl)Chloroborane as a Compound of Formula (I)

38 mg of a solution of Bis(bicyclo[2.2.1]-2-heptyl)chloroborane marketed under reference 771880 by Sigma-Aldrich have been added to 4 mL of anhydrous tetrahydrofuran, followed by 15 mg of potassium. The resulting composition has been placed under a pure, dry dinitrogen atmosphere and under stirring for 12 hours. At the end of the reaction, the mixture is brown in colour. An excess of HCI (2 M) in Et₂O has been added under an inert atmosphere, allowing quantitative conversion of Hx-N(BBCH₂)₃₋ₓ into NH₄⁺ and BCH₂BCl. Solvents and volatile compounds were removed by evaporation, leaving a solid residue. This solid is extracted with hexane, allowing separation of BCH₂BCl from NH₄⁺.

NH₄⁺ is obtained as a white solid. The yield with respect to the Bis(bicyclo[2.2.1]-2-heptyl)chloroborane initially introduced is 43%.

### Example 6: Process for Producing Ammoniacal Nitrogen from Dinitrogen Implementing Dicyclohexylchloroborane as a Compound of Formula (I) at Different Pressures

In an autoclave, 120 mg of a solution of dicyclohexylchloroborane (1 M in hexane) marketed under reference 411124 by Sigma-Aldrich have been added to 4 mL of anhydrous tetrahydrofuran, followed by 15 mg of potassium. The autoclave has then been sealed. The resulting composition has been pressurised (20 bar: example 6-1, 40 bar: example 6-2 and 80 bar: example 6-3) with pure, dry dinitrogen and under stirring for 12 hours. At the end of the reaction, the mixture is brown in colour. An excess of HCI (2 M) in Et₂O has been added under an inert atmosphere, allowing quantitative conversion of Hx-N(BCy₂)₃₋ₓ into NH₄⁺ and Cy₂BCl. Solvents and volatile compounds are removed by evaporation, leaving a solid residue. This solid is extracted with hexane, allowing separation of Cy₂BCl from NH₄⁺.

NH₄⁺ is obtained as a white solid. The yield with respect to the Cy₂BCl initially introduced is:
60% for a pressure of 20 bar (example 6-1)
76% for a pressure of 40 bar (example 6-2)
94% for a pressure of 80 bar (example 6-3).

1-15. (canceled)

16. A process for producing ammoniacal nitrogen, the ammoniacal nitrogen being selected from ammonium (NH₄⁺), ammonia (NH₃), and a mixture thereof, wherein the process comprises at least the following steps:
i) a step of bringing a composition comprising a compound responding to a following formula (I): R¹R²MY (I), a reducing agent, and an organic solvent, into contact with dinitrogen (N₂),
said formula (I) being such that:
M is an element of group 13 of the periodic table,
R¹ and R², identical or different, are selected from an alkyl group, an aryl group, an aryl-alkyl group, an —OR group and an —SR group, R being an alkyl group, an aryl group or an aryl-alkyl group, and
Y is a group selected from a halogen —X, an —OR³ group, an —SR³ group, a triflate group, a mesylate group, and a triflimidate group, R³ being an alkyl group, an aryl group, or an aryl-alkyl group, and
ii) a hydrolysis step in acidic medium.

17. The process according to claim 16, wherein the element M is selected from boron, aluminium and a mixture thereof.

18. The process according to claim 16, wherein the two groups R¹ and R² are alkyl groups.

19. The process according to claim 16, wherein Y is a halogen X.

20. The process according to claim 16, wherein the reducing agent is selected from potassium, sodium, mercury- and sodium-based amalgams, lithium, and a mixture thereof.

21. The process according to claim 16, wherein step i) is carried out at a temperature ranging from −80° C. to 60° C.

22. The process according to claim 16, wherein the reducing agent used in step i) represents from 0.1% to 20% by weight, relative to the total weight of the composition.

23. The process according to claim 16, wherein the compound of formula (I) used in step i) represents from 0.1% to 10% by weight relative to the total weight of the composition.

24. The process according to claim 16, wherein step ii) of hydrolysis in acidic medium is implemented by bringing a reaction crude obtained in preceding step i) into contact with an acidic solution or with a gaseous acid.

25. The process according to claim 24, wherein the acidic solution has a pH ranging from 0 to 6.

26. The process according to claim 16, wherein the organic solvent of step i) is selected from apolar aprotic organic solvents.

27. The process according to claim 16, wherein the process further comprises, after step i) and before step ii), a step i′) of evaporating the organic solvent.

28. The process according to claim 16, wherein the organic solvent of step i) is selected from ionic liquids.

29. The process according to claim 16, wherein the process further comprises a purification step i″) after step i) or step i′) if present, by extracting a reaction mixture formed in step i) or step i′) if present, using an apolar organic solvent.
